(19) United States
(12) Patent Application Publication
(10) Pub. No.: US 2022/0198255 A1
(43) Pub. Date: Jun. 23, 2022

(54) TRAINING A SEMANTIC PARSER USING ACTION TEMPLATES

(71) Applicant: INTERNATIONAL BUSINESS MACHINES CORPORATION, Armonk, NY (US)

(72) Inventors: Corentin Jacques Andre Sautier, Groslay (FR); Don Joven Ravoy Agravante, Tokyo (JP); Michiaki Tatsubori, Oiso (JP)

(21) Appl. No.: 17/124,945

(22) Filed: Dec. 17, 2020

(51) Int. Cl. G06N 3/08; G06F 40/30; G06F 40/205

(52) U.S. Cl. CPC G06N 3/08; G06F 40/205; G06F 40/30

(57) ABSTRACT

Methods and systems for training a semantic parser includes performing an automated intervention action in a text-based environment. An inverse action is performed in the text-based environment to reverse the intervention action. States of the text-based environment are recorded before and after the intervention action and the inverse action. The recorded states are evaluated to generate training data. A semantic parser neural network model is trained using the training data.

### BACKGROUND

The present invention generally relates to natural language processing, and, more particularly, to training a semantic parser for natural language tasks without the use of labels.

Semantic parsing attempts to convert the meaning of a natural language input into a machine-usable representation. However, training a semantic language parser for a particular environment can be challenging, as it may use difficult-to-produce training labels. For example, a semantic parser may accept a natural language input and may generate a logic statement output—training data that includes pairs of these inputs and outputs are typically generated manually. Furthermore, because there may be several ways to express a given logic statement, the person labeling the information needs to understand the logic.

### SUMMARY

A computer-implemented method for training a semantic parser includes performing an automated intervention action in a text-based environment. An inverse action is performed in the text-based environment to reverse the intervention action. States of the text-based environment are recorded before and after the intervention action and the inverse action. The recorded states are evaluated to generate training data. A semantic parser neural network model is trained using the training data.

A system for training a semantic parser includes a hardware processor and a memory that stores computer program code. When executed by the hardware processor, the computer program code implements an exploration agent, a state evaluator, and a model trainer. The exploration agent performs an automated intervention action in a text-based environment, performs an inverse action in the text-based environment to reverse the intervention action, and records states of the text-based environment before and after the intervention action and the inverse action. The state evaluator evaluates the recorded states to generate training data. The model trainer trains a semantic parser neural network model using the training data.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram that illustrates illustrations with a text environment that may be used to explore the text environment, verifying various propositions to be used in training a semantic parser, in accordance with an embodiment of the present invention;

FIG. 2 is a block/flow diagram of a method for training a semantic parser using automated exploration of a text environment to generate pseudo-labels, in accordance with an embodiment of the present invention;

FIG. 3 is a block/flow diagram of a method for interacting with a text environment to collect information about the environment, in accordance with an embodiment of the present invention;

FIG. 4 is a block/flow diagram of a method for determining pseudo-labels for propositions relating to the state of a text environment, in accordance with an embodiment of the present invention;

FIG. 5 is a block/flow diagram of a method for training a semantic parser using automated exploration of a text environment to generate pseudo-rewards, in accordance with an embodiment of the present invention;

FIG. 6 is a block diagram of a semantic parser system with automatic text environment exploration, in accordance with an embodiment of the present invention;

FIG. 7 is a block diagram of a semantic parser model, in accordance with an embodiment of the present invention;

FIG. 8 is a diagram of a high-level neural network architecture that may be used to implement a semantic parser model, in accordance with an embodiment of the present invention;

FIG. 9 is a block diagram showing an illustrative cloud computing environment having one or more cloud computing nodes with which local computing devices used by cloud consumers communicate in accordance with one embodiment; and

FIG. 10 is a block diagram showing a set of functional abstraction layers provided by a cloud computing environment in accordance with one embodiment.

### DETAILED DESCRIPTION

Rather than relying on hand-labeled text/logic training pairs, semantic parsing models may be trained using causal action templates. These templates are defined in advance, and are then populated automatically for a variety of inputs to generate pseudo-labels (for supervised or semi-supervised learning) or pseudo-rewards (for reinforcement learning). The pseudo-labels or pseudo-rewards may be used to train a neural network model, for example using noise-resistant training methods or semi-supervised methods.

The causal action templates abstract away the dependency on labeling specific natural language inputs, as they can accommodate multiple different ways of expressing a single logical meaning. In addition, the logic set may be set in an application domain, such that a limited number of action templates can capture the important states.

As will be described in greater detail below, the action templates may include preconditions and effects relating to an action, for example describing the effects that occur when the action is performed in an environment that meets the listed preconditions. The action templates may furthermore include inverses for each action, that return the environment to a state from before the action was performed.

The semantic parsing model that has been trained using such action templates can then be used in a variety of natural language tasks. Examples are given herein that deal with exploring a text-based game, where information about the world is provided in the form of text, and where the system can interact with the world by providing various text-based commands.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

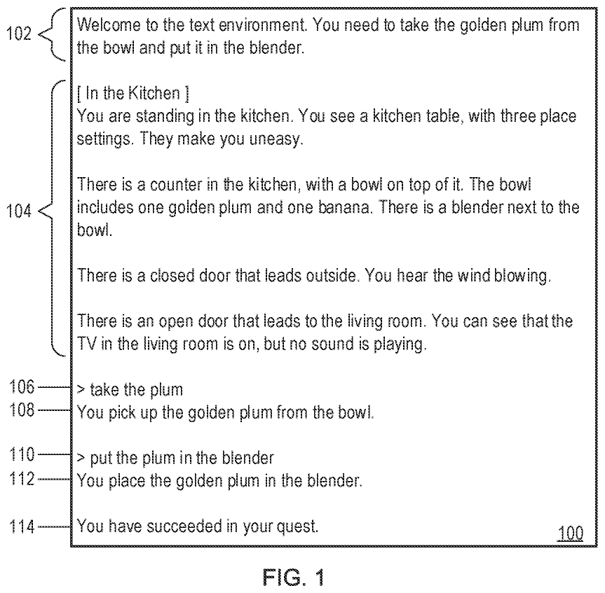

Referring now to FIG. 1, a text interface 100 is shown. The text interface 100 represents an environment that a natural language processing system may interact with to learn semantic and logical relationships between words. The environment may be automatically generated, or may be designed by a human operator, or may include predesigned elements and automatically generated elements. The environment includes various objects and settings, which are described in text. The system inputs commands, based on action templates and its understanding of the environment, and the environment describes the results of these actions.

In some cases, various rules may be used to evaluate the results, with the outcome being used as a pseudo-reward for reinforcement learning. In some cases, pseudo-labels may be generated from user-generated rewards, by performing actions and assessing the results. In either case, the semantic information that is learned from the environment can be used to train a semantic parsing model, which may be used for a wide variety of tasks. For example, semantic parsing models are a core component in applications such as automated question answering, voice assistants, and automated code generation.

The text interface 100 provides a goal 102 that the system may work towards. Satisfying the goal may generate a reward, while failing to satisfy the goal may generate no reward, or may generate a “noisy” reward. A description of the visible environment 104 is provided. This description may include features that are not relevant to the goal, may include features that are not immediately accessible, and may omit features that are present in the environment but that are, at least temporarily, hidden. Actions may be performed within the environment, which prompts a new observation of the state of the environment, and may indicate the success or failure of the action.

The system may issue a first command 106, which generates a first response 108. The first response 108 describes how the state of the environment has changed from that provided in the description 104. The system may then issue a second command 110. The second command 110 generates a second response 112, which describes further changes to the state of the environment. Having satisfied the goal 102, a reward 114 is indicated.

Based on the initial description 104, various piece of information may be extracted that describe the state of the environment. For example, the statement “at agent kitchen” represents the fact that the description places the agent (e.g., the user or system) in the kitchen. The statement “at bowl kitchen” represents the fact that the description places the bowl in the kitchen. The statement “at golden-plum bowl” represents the fact that the plum is in the bowl. After performing the first command 106, the state of the environment changes to lose the “at golden-plum bowl” attribute and to gain a “carry golden-plum” attribute, representing the fact that the agent has picked up the golden plum. Similarly, after performing the second command 108, the state of the environment changes to lose the “carry golden-plum” attribute and to gain the “at golden-plum blender” attribute.

In this manner, the agent explores the environment to determine facts about the environment. For example, based on how the state changes when the system issues commands regarding an object, the system can determine information about the state of that object, even if the information was not explicitly provided in the description 104.

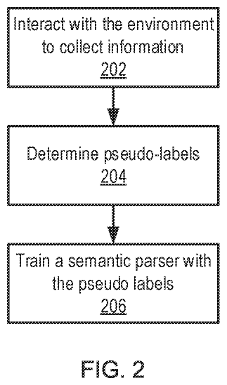

Referring now to FIG. 2, a high-level method for training a semantic parser model is shown, using action templates. Block 202 performs one or more interactions, where a system agent performs actions within the environment, based on a set of pre-defined action templates. Based on the outcomes of these interactions, a set of rules can be used in block 204 to determine pseudo-labels for various natural language outcomes. Using these pseudo-labels, a semantic parser model can be trained in block 206.

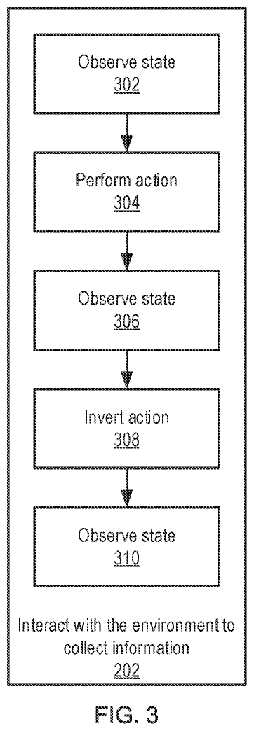

Referring now to FIG. 3, a method of evaluating a proposition within an environment is shown. An example of such a proposition may be, for example, “The blender is on the counter.” Block 302 observes the state, for example by parsing the information provided in the description 104. This observation may include performing active observations, such as issuing a “look” command, to gather information about the state of the environment. The observation sets various environment attributes, as described above, which may be used in action templates.

Block 304 performs an action in the environment, for example an action that relates to the proposition. In this case, the action may be, “Take the blender.” Block 306 observes the state that results from performing the action 304, for example observing that the interface has provided the response, “You pick up the blender from the counter.” Additional information-gathering actions may be performed in block 306 to further assess the new state of the environment. In some cases, the action may fail, for example based on receiving an error response. If the action fails, then it may be concluded that the environment has not changed.

In performing the action, the system makes use of action templates that define, for example, how a given action interacts with the environment. These action templates may be predefined, along with information about objects and features of the environment. The following is an example of an action template for the action “take”:

| | |
|---|---|
| (:action | //Defines the action name. |
| take | |
| :parameters | //Defines parameters that may be specified for the |
| (?obj - object | //action. For example, an object and a location. |

?room - room)

| | |
|---|---|
| :precondition | //Defines preconditions that are needed to perform the |
| (and | //action. |

```
    (at ?obj ?room)
    (at-agent ?room))
```

| | |
|---|---|
| :effect | //Defines the results of successful performance of the |
| (and | //action. |

```
    (carry ?obj)
    (not (at ?obj ?room)))
)
```

Thus, if the starting state of the environment includes these initial attributes, “at bowl kitchen,” “at agent kitchen,” and “not (carry bowl),” then the state that follows the action of taking the bowl may include, “at-agent kitchen,” “carry bowl,” and, “not (at bowl kitchen)”.

If the action was successful, block 308 then performs the inverse action, which may be directed to return the state to its original state. Following the example above, the inverse action may be, “Put the blender on the counter.” It should be understood that the structure of the inverse is part of the action template parameterization that is to be verified. For example, putting the bowl helps to test whether the bowl was on the counter in the first place, which can be detected if the end state deviates from the initial state. The inverse action need not be a valid action, and the failure of such an action is also instructive. Rule based semantic parsers may be used to estimate the original state and to narrow down a set of action/inverse actions that can be performed. For example, a semantic parser may be used to filter the initial observation for nouns, such that those nouns can then be used as parameters.

Block 310 then observes the state that results from the inverse action 308, optionally including any additional information-gathering actions. This observation may, for example, confirm that the end state of the environment is the same as the beginning condition, and may further note any differences that have occurred, despite performing the inverse action.

In this manner, the system can procedurally explore the environment and collect information about the relationships between various environment elements. Although only a single action, and its inverse, are shown, it should be understood that multiple actions may be performed in sequence to explore different parts of the logic state.

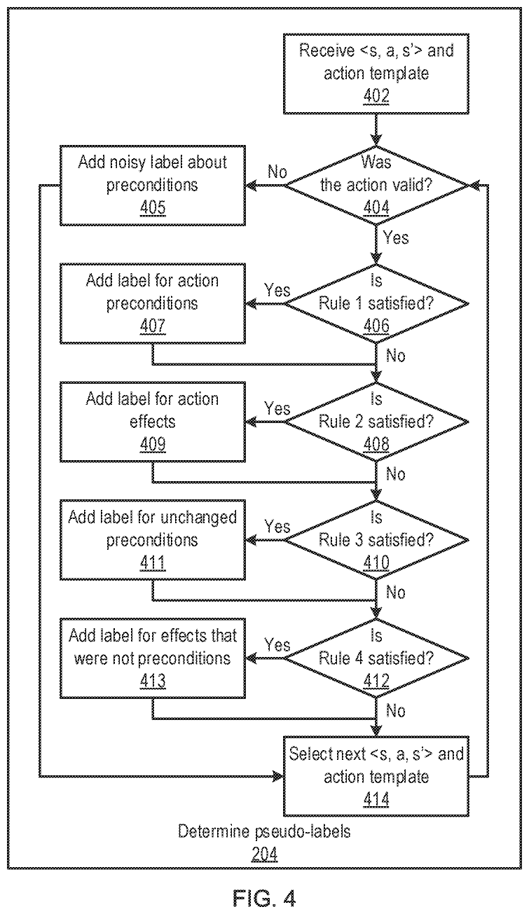

Referring now to FIG. 4, additional detail is provided on how pseudo-labels may be determined in block 204. Block 402 receives information from the interactions of block 202, which may include an initial state s, an action a that was performed, and an ending state s′ that resulted from the action. This information may include the preconditions for the action and the effects of the action, derived from an action template associated with a.

Block 404 determines whether the action was valid. For example, if the action was attempted but did not succeed, some information can be gleaned from this fact regarding the preconditions that were present in the initial state s. However, complete information regarding the failure of the action a may not be available. For example, if there are multiple preconditions needed to perform a, then its failure may reflect the absence of any or all of those preconditions. As such, noisy labels regarding the truth of one or more propositions may be added in block 405, to reflect this ambiguity. For example, rather than a label that indicates truth (e.g., a ‘1’) or a label that indicates false (e.g., a ‘0’), the label may have a value between those extremes (e.g., ‘0.7’) to reflect a degree of confidence. In some cases, binary values may be applied in individual cases, with multiple samples being evaluated to identify the statistical likelihood of each outcome.

If the action did succeed, then a set of rules may be used to determine the appropriate labels. The rules relate to truth propositions, for example assertions relating to various objects and relationships and objects in the observed stated. For example, “at agent kitchen” is a proposition that may be true if the agent is in the location “kitchen,” and may be false if the agent is in another location. These rules may include:

Rule 1: If the action worked, the preconditions were all met for the initial state.

Rule 2: If the action worked, the effects are all met for the new state.

Rule 3: If a proposition in the preconditions is not canceled in the effects, it is still true in the new state.

Rule 4, If a proposition is in the effects, but was not in the preconditions, it can be assumed that the proposition was false in the initial state.

Block 406 determines whether Rule 1 is satisfied and, if so, block 407 adds truth labels for propositions related to the preconditions of the action, as defined in the action template. Rule 408 determines whether Rule 2 is satisfied and, if so block 409 adds truth labels for propositions related to the effects of the action, as defined in the action template. Rule 410 determines whether Rule 3 is satisfied and, if so, block 411 adds truth labels for propositions relating preconditions that were present in the preconditions and that were not altered by the effects of the action, as defined in the action template. Rule 412 determines whether Rule 4 is satisfied and, if so, block 413 adds truth labels for truth propositions that were listed in the effects but were not described in the preconditions. Once the labels for this action have been determined, block 414 selects the results of the next action from block 202 and the process is repeated.

These automatically generated labels, or “pseudo-labels” to distinguish them from labels that are determined by a human operator, may be used in block 206 to train a semantic parser. Multiple interactions, across multiple different agents, may be combined to form a single training dataset. The training data includes a set of natural language observations for particular environment states (e.g., “The golden plum is in the bowl.”) and associated pseudo-labels. The trained semantic parser can then take new natural language propositions and generate corresponding labels to predict the truth states of those propositions.

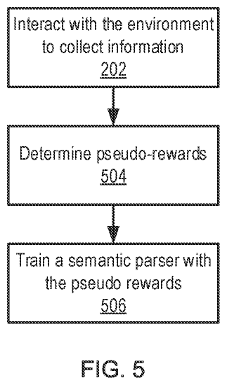

Referring now to FIG. 5, a high-level method for training a semantic parser model is shown, using fact verification. As in FIG. 2, described above, block 202 interacts with the environment to collect information. Such interactions may include the performance of intervention actions and observing the outcomes.

Rather than using action templates and determining pseudo-labels, as described above, block 506 determines pseudo-rewards for various observed states of the environment. For example, an observed state may represent a set of different attributes, {a, b, c}. For example, such an attribute may be “at agent kitchen” to indicate that the agent is in the location “kitchen.” The pseudo-rewards may apply to the entire state, and may be used to verify the truth of some proposition. For example, if the proposition is, “The golden plum is in the bowl,” then an action may be used to test this proposition. For example, if the action is, “take the plum,” and the action fails, then block 504 may determine that the preconditions for the action (e.g., the plum being in the bowl) were false, providing a reward value of ‘0’ for the proposition.

If the action is successful, then information about what happens when the action is reversed may provide further information. For example, if the end state, after performing the action and the inverse action, is the same as the initial state, then a reward of ‘1’ can indicate that the proposition was true and that the state of the environment is unchanged. If the end state has differed, for example because the “plum” started in some location other than the bowl, and was then put into the bowl when the inverse action was applied, then a reward of ‘0’ can indicate that the proposition was false and that the state of the environment has changed as a result of the actions. Block 506 can then use this reward information for reinforcement learning with a semantic parser.

The semantic parser may, for example, represent the information about the environment in the form of the planning domain definition language (PDDL), which can be used for an automatic planner to determine a course of action in the environment. PDDL may include first-order/predicate language, where a PDDL state may be defined as a conjunction of every true proposition in the environment at a given time. Each proposition may include a predicate function and its arguments (e.g., the objects in the environment). Using such a framework, the environment may be automatically mapped, such that future actions to be taken in the environment, or in similar environments, may be executed with confidence.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

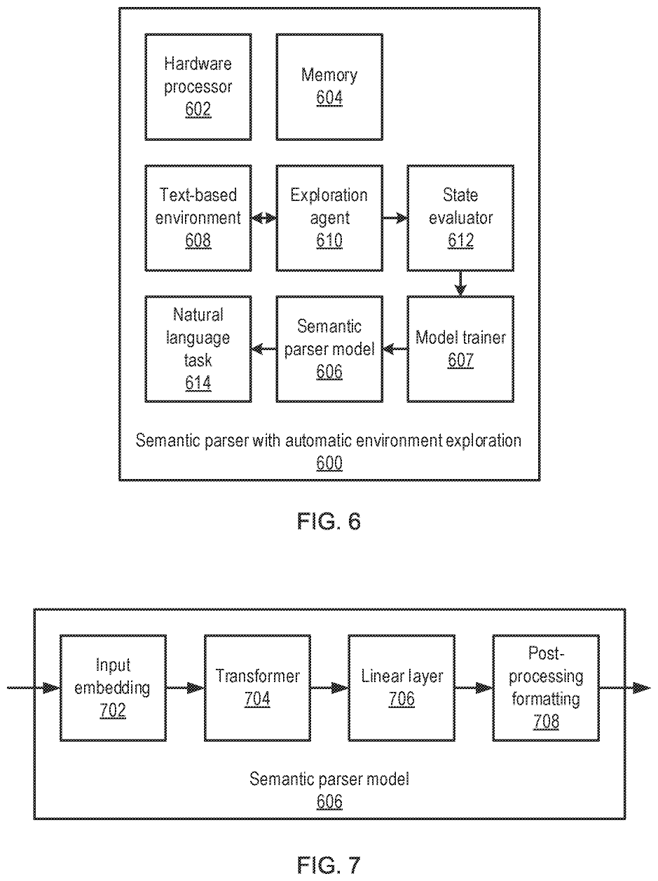

Referring now to FIG. 6, a semantic parser 600 is shown with automatic environment exploration. The system 600 includes a hardware processor 600 and a memory 604, as well as a semantic parser model 606. As will be described in greater detail below, the semantic parser model 606 may be a neural network model that is trained by model trainer 607, using a training dataset.

To generate the training dataset, an exploration agent 610 interacts with a text-based environment 608. As described above, the text-based environment 608 may include a procedurally generated world, with objects and with a goal to accomplish. The exploration agent 610 performs actions within the text-based environment 608 to determine the effects of various actions. A state evaluator 612 takes the observed states of the environment, responsive to the actions performed by the exploration agent 610, and determines pseudo-rewards or pseudo-labels for various propositions or actions. This information is used as the training data for the model trainer 607, which trains the semantic parser model 606 to evaluate the truth of propositions.

A natural language task 614 can then be performed, using the semantic parser model 606 to help navigate a new environment. For example, if the semantic parser is trained to output a logic program in the form of a PDDL, this can then be used with to provide a plan (e.g., a sequence of actions in an environment) that can take the agent from a current state to a certain goal state.

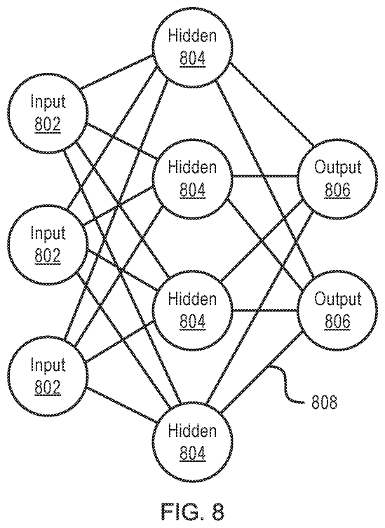

Referring now to FIG. 7, a diagram of the semantic parser model 606 is shown. A logical proposition is received at information embedding 702, where it is represented in a machine-readable format, such as a vector in a latent space. The embedded input is processed by, e.g., a transformer layer 704. Transformers are encoder-decoder models that encode the embedded input text using stacked multi-head self-attention layers, and then decode with a similar structure of stacked multi-head attention using the output sequence as an auto-regressive input. The output of the transformer layer 704 is processed by a linear layer 706. Post-processing formatting 708 is then performed to generate the output of the semantic parser. Post-processing may include formatting, such as adding parentheses to logic outputs that may be used by a downstream task. For example, if the output of the neural network is, “at apple kitchen,” indicating that the object “apple” is in the location “kitchen,” then the downstream planner may need it to be reformatted to, “(at apple kitchen)”. Although not shown in this embodiment, a pointer layer may also be used to help the model handle syntactic information.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

Referring now to FIG. 8, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 808 may be implemented as resistive processing units (RPUs), generating a predictable current output when an input voltage is applied in accordance with a settable resistance.

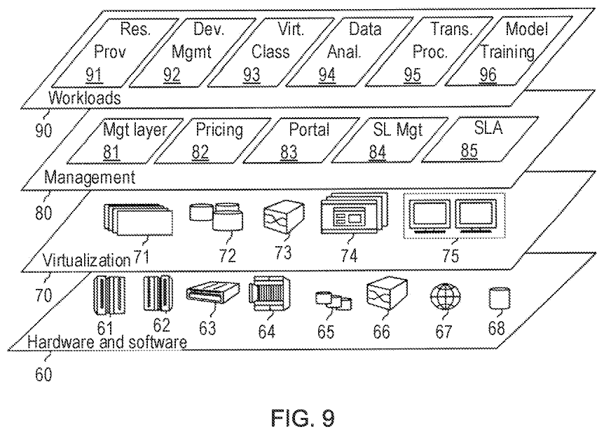

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

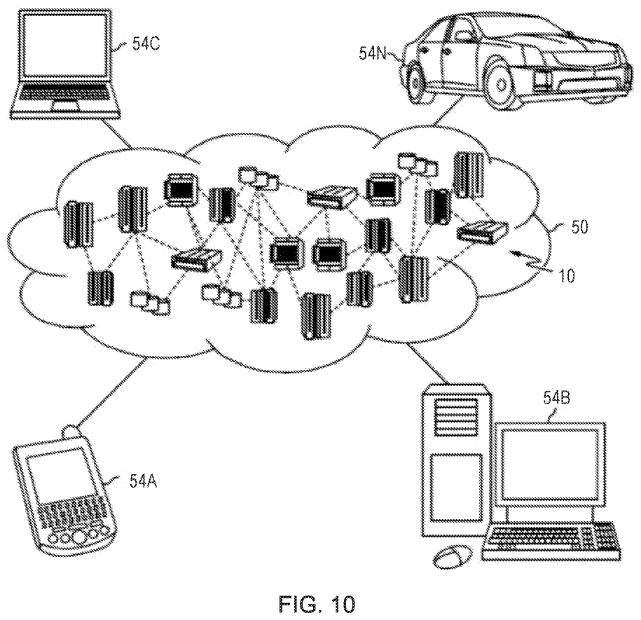

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and model training 96.

Having described preferred embodiments of training a semantic parser using action templates (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for training a semantic parser, comprising:
performing an automated intervention action in a text-based environment;
performing an inverse action in the text-based environment to reverse the intervention action;
recording states of the text-based environment before and after the intervention action and the inverse action;
evaluating the recorded states to generate training data; and
training a semantic parser neural network model using the training data.

2. The method of claim 1, wherein evaluating the recorded states includes determining pseudo-labels for logical propositions based on one or more rules.

3. The method of claim 2, wherein training the semantic parser neural network model includes supervised learning using the pseudo-labels.

4. The method of claim 2, wherein the one or more rules derive one or more pseudo-labels from an action template, associated with the intervention action, that includes precondition propositions and effect propositions for the intervention action.

5. The method of claim 4, wherein the action template includes parameters that an action accepts, preconditions for success of the action, and effects that occur upon success of the action.

6. The method of claim 2, wherein the one or more rules include a rule selected from the group consisting of a first rule relating to preconditions of an action template for a successful action, a second rule relating to effects of the action template for the successful action, a third rule relating to preconditions of the action template for the successful action that are not canceled in the effects of the action template, and a fourth rule relating to effects of the action template for the successful action that are not in the preconditions of the action template.

7. The method of claim 2, wherein a noisy pseudo-label is determined responsive to a determination that the intervention action is unsuccessful.

8. The method of claim 1, wherein evaluating the recorded states includes determining a pseudo-reward for the intervention action, based on the recorded states and a goal state.

9. The method of claim 8, wherein training the semantic parser neural network model includes reinforcement learning using the pseudo-reward.

10. The method of claim 8, wherein the pseudo-reward for the intervention action is determined based on a goal within the environment.

11. A non-transitory computer readable storage medium comprising a computer readable program for training a semantic parser, wherein the computer readable program when executed on a computer causes the computer to:
perform an automated intervention action in a text-based environment;
perform an inverse action in the text-based environment to reverse the intervention action;
record states of the text-based environment before and after the intervention action and the inverse action;
evaluate the recorded states to generate training data; and
train a semantic parser neural network model using the training data.

12. A system for training a semantic parser, comprising:
a hardware processor; and
a memory that stores computer program code which, when executed by the hardware processor, implements:
an exploration agent that performs an automated intervention action in a text-based environment, that performs an inverse action in the text-based environment to reverse the intervention action, and that records states of the text-based environment before and after the intervention action and the inverse action;
a state evaluator that evaluates the recorded states to generate training data; and
a model trainer that trains a semantic parser neural network model using the training data.

13. The system of claim 12, wherein the state evaluator determines pseudo-labels for logical propositions based on one or more rules using the recorded states.

14. The system of claim 13, wherein the model trainer performs supervised learning using the pseudo-labels.

15. The system of claim 13, wherein the one or more rules derive one or more pseudo-labels from an action template, associated with the intervention action, that includes precondition propositions and effect propositions for the intervention action.

16. The system of claim 15, wherein the action template includes parameters that an action accepts, preconditions for success of the action, and effects that occur upon success of the action.

17. The system of claim 13, wherein the one or more rules include a rule selected from the group consisting of a first rule relating to preconditions of an action template for a successful action, a second rule relating to effects of the action template for the successful action, a third rule relating to preconditions of the action template for the successful action that are not canceled in the effects of the action template, and a fourth rule relating to effects of the action template for the successful action that are not in the preconditions of the action template.

18. The system of claim 12, wherein the state evaluator determines a pseudo-reward for the intervention action, based on the recorded states and a goal state.

19. The system of claim 18, wherein the model trainer performs reinforcement learning using the pseudo-reward.

20. The system of claim 18, wherein the state evaluator determines the pseudo-reward for the intervention action based on a goal within the environment.
